(19) United States
(12) Patent Application Publication
(10) Pub. No.: US 2017/0204917 A1
(43) Pub. Date: Jul. 20, 2017

(54) One-Way Clutch With Electro-Magnetic Solenoid

(71) Applicant: Ford Global Technologies, LLC, Dearborn, MI (US)

(72) Inventors: Norman Jerry Bird, Plymouth, MI (US); Mark Gerard Czapski, Novi, MI (US)

(21) Appl. No.: 15/256,921

(22) Filed: Sep. 6, 2016

Related U.S. Application Data
(60) Provisional application No. 62/280,297, filed on Jan. 19, 2016.

(51) Int. Cl. F16D 27/09; F16D 41/12

(52) U.S. Cl. CPC F16D 27/09; F16D 41/12

(57) ABSTRACT

A controllable one-way clutch includes a first race and a second race. The first race has a periphery with a tooth. The second race has a rocker with an associated solenoid. The rocker is pivotable between a first position and a second position. In the first position, the rocker is engaged with the tooth. In the second position, the rocker is disengaged from the tooth. The solenoid has an armature arranged to move the rocker from the first position to the second position and/or from the second position to the first position.

### CROSS-REFERENCE TO RELATED APPLICATIONS

This application claims the benefit of U.S. provisional application Ser. No. 62/280,297 filed Jan. 19, 2016, the disclosure of which is hereby incorporated in its entirety by reference herein.

### TECHNICAL FIELD

The present disclosure relates to one-way clutches, particularly those used in automotive vehicle transmissions.

### BACKGROUND

A one-way clutch generally includes an inner race coupled to a first rotatable component and an outer race coupled to a second rotatable component. The one-way clutch engages to transfer torque between the inner race and outer race when the relative rotation between the first and second components is in one direction, and disengages to free wheel when the relative rotation is in a second direction. Some one-way clutch arrangements are controllable to operate in multiple modes. As an example, the inner and outer races can be selectively maintained in a disengaged state to free wheel in both directions of relative rotation, and/or selectively maintained in an engaged state to transfer torque in both directions of relative rotation.

### SUMMARY

A controllable one-way clutch according to the present disclosure includes a first race and a second race. The first race has a periphery with a tooth. The second race has a rocker with an associated solenoid. The rocker is pivotable between a first position and a second position. In the first position, the rocker is engaged with the tooth. In the second position, the rocker is disengaged from the tooth. The solenoid has an armature arranged to move the rocker from the first position to the second position or from the second position to the first position.

According to a first embodiment, the first race is an inner race, and the second race is an outer race arranged concentrically with the inner race.

According to a second embodiment, the rocker has a central portion with a pivot axis passing through the central portion. The rocker additionally has an elbow projected from the central portion in a first direction, and an arm projected from the elbow in a second direction. The second direction is distinct from the first direction. The armature is arranged to contact the arm or the elbow.

In one variant of the second embodiment, a resilient member is arranged to apply a bias force to the elbow to bias the rocker to the second position. In such a variant, the armature is arranged to selectively apply force to the arm to move the rocker from the second position to the first position.

In another variant of the second embodiment, a resilient member is arranged to apply a bias force to the arm to bias the rocker to the first position. In such a variant, the armature is arranged to selectively apply force to the elbow to move the rocker from the first position to the second position.

In yet another variant of the second embodiment, the armature is mechanically connected to the arm or the elbow to move the rocker from the first position to the second position and from the second position to the first position.

In still another variant of the second embodiment, the second race includes a periphery provided with a recessed pocket, with the rocker disposed within the pocket and pivotable within the pocket. In such a variant, when in the first position the arm projects from the pocket and in the second position the arm is retained within the pocket. The second race may include a face with a slot opening thereto, with the slot being in communication with the pocket. In such a variant, the solenoid is disposed within the slot.

A controllable one-way clutch assembly according to the present disclosure includes a first annular ring and a second annular ring. The first annular ring has a central axis of rotation, a first periphery, and at least one tooth arranged about the first periphery. The second annular ring is arranged concentrically with the first annular ring. The second annular ring has a second periphery and a pocket recessed within the second periphery. The assembly additionally includes a pivotable member arranged within the pocket. The pivotable member has a pivot axis passing through the pocket, with the pivot axis being generally parallel with the axis of rotation. The pivotable member is pivotable about the pivot axis between an engaged position and a disengaged position. In the engaged position the pivotable member is engaged with the tooth and, in the disengaged position the pivotable member is disengaged from the tooth. The assembly further includes an electromechanical actuator having a movable member. The movable member is arranged to apply force to the pivotable member and move the pivotable member from the engaged position to the disengaged position or from the disengaged position to the engaged position.

According to a first embodiment, the pivotable member includes a first portion extending in a first direction from the axis of rotation and a second portion extending in a second direction from the first portion. In such an embodiment, the movable member is configured to apply force to one of the first portion and the second portion.

According to a variant of the first embodiment, the assembly additionally includes a resilient member arranged to apply a bias force to the other of the first portion and the second portion.

According to another variant of the first embodiment, the movable member is mechanically coupled to the one of the first portion and the second portion. In such a variant, the movable member is configured to move the pivotable member from the engaged position to the disengaged position and from the disengaged position to the engaged position.

According to a second embodiment, the second annular ring has a face extending generally orthogonal to the axis of rotation. In such an embodiment, the second annular ring includes a channel opening to the face and in communication with the pocket. The electromechanical actuator is disposed in the channel.

According to a third embodiment, the electromechanical actuator includes a solenoid and the movable member includes an armature of the solenoid.

Embodiments according to the present disclosure provide a number of advantages. For example, one-way clutches according to the present disclosure make use of readily-available components, and may be manufactured using fewer machining or forming steps than known clutches. As a result, one-way clutches according to the present disclosure may be manufactured more simply and inexpensively than known clutches. Moreover, embodiments according to the present disclosure may be more energy-efficient than known one-way clutches.

The above advantage and other advantages and features of the present disclosure will be apparent from the following detailed description of the preferred embodiments when taken in connection with the accompanying drawings.

### BRIEF DESCRIPTION OF THE DRAWINGS

FIG. 1 is a pictorial view of a one-way clutch;

FIG. 2 is a detail view of a one-way clutch having a single-acting solenoid and a return spring; and

FIG. 3 is a detail view of a one-way clutch having a double-acting solenoid.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

In the following discussion of the Figures, a polar coordinate system is utilized. An axial direction extends along an axis of rotation of the clutch. A radial direction extends orthogonal to the axial direction from the axis of rotation toward a periphery of the clutch. A circumferential direction extends orthogonal to the radial direction within the general plane of the clutch.

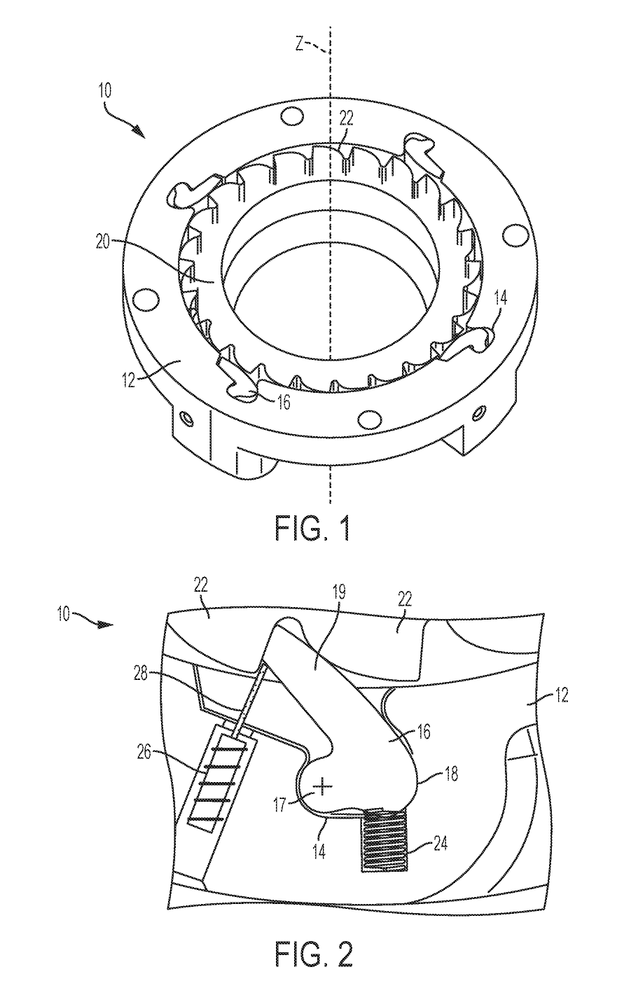

Referring now to FIGS. 1 and 2, a one-way clutch 10 according to the present disclosure is illustrated. The one-way clutch 10 includes an outer race or rocker plate 12. The rocker plate 12 is generally shaped as an annular ring. The rocker plate may be held against rotation, e.g. secured by fasteners to a fixed member or housing. The rocker plate includes pockets 14, each pocket 14 containing a corresponding rocker 16. The rockers 16 are pivotable members retained within the respective pockets 14. The rockers 16 are arranged to pivot within the respective pockets 14 about a pivot axis passing through a central portion 17. Each rocker 16 includes a first portion or elbow 18 spaced from the pivot axis and a second portion or arm 19 extending from the elbow.

The clutch 10 also includes an inner race with a cam plate 20. The cam plate 20 is generally shaped as an annular ring. The cam plate 20 is configured to rotate about an axis of rotation Z, e.g. secured by fasteners to a rotatable shaft. The pivot axes of the rockers 16 are generally parallel with the axis of rotation Z. The cam plate 20 has a plurality of recesses that define teeth 22. When the rockers 16 are pivoted relative to the pockets 14, the arms 19 project inwardly from the pocket and may catch on the teeth. In this embodiment, a resilient member or spring 24 exerts a bias force on the elbow 18 to maintain the rockers 16 within the pockets without protruding. In this position, there is no engagement between the rocker arms 19 and the teeth 22, and thus no torque is transferred between the rocker plate 12 and cam plate 20. FIG. 1 illustrates the clutch 10 in this disengaged position.

The cam plate 20 includes a solenoid 26 having an armature 28. The solenoid 26 may be of any conventional type, selected according to requirements of a given application. In response to an electrical current, a coil within the solenoid 26 generates a magnetic field. The magnetic field drives the armature 28 to exert a force on the rocker arm 19. In response to the force, the rocker 16 pivots radially outward from the pocket 14 against the bias force of the spring 24, such that the rocker arm 19 protrudes beyond a radially inward face of the rocker plate 12. The rocker arm 19 may engage with a tooth 22 and transfer torque between the rocker plate 12 and cam plate 20 in one direction of rotation. FIG. 2 illustrates the clutch 10 in this engaged position. In this engaged position, when a torque is applied on the cam plate 20 in a clockwise direction as viewed in FIG. 2, the rockers 16 ratchet on the teeth 22 and the cam plate 20 may rotate. When a torque is applied on the cam plate 20 in a counter-clockwise direction as viewed in FIG. 2, the rockers 16 prevent rotation of the cam plate 20.

In response to discontinuation of the electrical current, the armature 28 returns to the original position. The bias force of the spring 24 may then pivot the rocker 16 about the pivot axis to return the rocker arm 19 to the pocket 14 and return the clutch 10 to the disengaged position.

Advantageously, the rocker plate 12 may be formed as a single integral piece via cast aluminum or powdered metallurgy. The pockets 14 may be formed into the rocker plate 12 at the time of initial manufacture. Thus, little additional machining is needed.

According to one embodiment, the solenoid 26 is retained in a through hole extending radially from an outer radial surface of the rocker plate 12 through an inner radial surface of the pocket 14. Such a through hole may be provided by a drill after the rocker plate 12 is formed. According to another embodiment, the solenoid 26 is retained in a slot extending axially from one axial face of the rocker plate 12. Advantageously, such a slot may be formed into the rocker plate 12 at the time of initial manufacture.

As may be seen, the embodiment illustrated in FIG. 2 includes a “single-acting open” solenoid 26, with spring return to the closed position.

Another embodiment includes a “single-acting closed” solenoid with spring return to the open position. In such an embodiment, a spring is arranged to exert a bias force on the rocker toward the open position, while a solenoid is arranged to selectively drive the rocker toward a closed position in response to application of an electric current. As an example, such an embodiment may include a spring arranged to exert a bias force on the rocker arm and a solenoid arranged to selectively apply force to the rocker elbow.

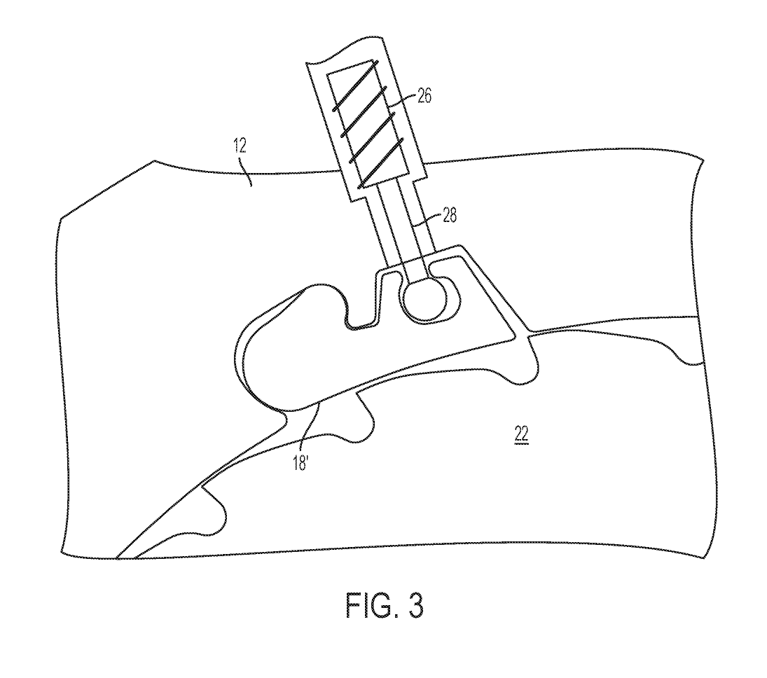

A further embodiment, illustrated in FIG. 3, includes a dual-acting solenoid. In such an embodiment, a mechanical connection is provided between the armature 28 of the solenoid 26 and the rocker 18′. Thus, as the armature slides in response to application or discontinuation of electric current, the rocker moves in conjunction with the armature. In such an embodiment, no bias spring is necessary to return the rocker to a starting position. In such an embodiment, the solenoid may be mechanically connected to the rocker arm, rocker elbow, or other appropriate locations.

In yet another embodiment, the rocker plate and rockers are provided on the inner race, while the cam plate is provided on the outer race.

Other considered embodiments may utilize other types of electromechanical actuators having movable members as appropriate.

As may be seen, embodiments according to the present disclosure provide a number of advantages. For example, a one-way clutch according to the present disclosure are relatively energy efficient due to the low energy usage of solenoids relative to hydraulic actuators or other known control mechanisms for one-way clutches. In addition, solenoids are common and inexpensive components, decreasing the overall cost of the one-way clutch.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A controllable one-way clutch comprising:
a first race having a periphery provided with a tooth; and
a second race having a rocker with an associated solenoid, the rocker being pivotable between a first position engaged with the tooth and a second position disengaged from the tooth, and the solenoid having an armature arranged to move the rocker from the first position to the second position or from the second position to the first position.

2. The controllable one-way clutch of claim 1, wherein the first race is an inner race, and the second race is an outer race arranged concentrically with the inner race.

3. The controllable one-way clutch of claim 1, wherein the rocker comprises a central portion, an elbow projected from the central portion in a first direction, and an arm projected from the elbow in a second direction, the second direction being distinct from the first direction, the rocker being arranged to pivot about a pivot axis passing through the central portion, the armature being arranged to contact the arm or the elbow.

4. The controllable one-way clutch of claim 3, further comprising a resilient member arranged to apply a bias force to the elbow to bias the rocker to the second position, wherein the armature is arranged to selectively apply force to the arm to move the rocker from the second position to the first position.

5. The controllable one-way clutch of claim 3, wherein the armature is mechanically connected to the arm or the elbow to move the rocker from the first position to the second position and from the second position to the first position.

6. The controllable one-way clutch of claim 3, wherein the second race includes a periphery provided with a recessed pocket, the rocker being disposed within the pocket and pivotable within the pocket, and wherein in the first position the arm projects from the pocket and in the second position the arm is retained within the pocket.

7. The controllable one-way clutch of claim 6, further comprising a slot opening to a face of the second race, the slot being in communication with the pocket, and the solenoid being disposed within the slot.

8. A controllable one-way clutch assembly comprising:
a first annular ring, the first annular ring having a central axis of rotation, a first periphery, and at least one tooth arranged about the first periphery;
a second annular ring arranged concentrically with the first annular ring, the second annular ring having a second periphery and a pocket recessed within the second periphery;
a pivotable member arranged within the pocket and having a pivot axis passing through the pocket, the pivot axis being generally parallel with the axis of rotation, the pivotable member being pivotable about the pivot axis between an engaged position and a disengaged position, wherein in the engaged position the pivotable member is engaged with the tooth and in the disengaged position the pivotable member is disengaged from the tooth; and
an electromechanical actuator having a movable member, the movable member being arranged to apply force to the pivotable member and move the pivotable member from the engaged position to the disengaged position or from the disengaged position to the engaged position.

9. The controllable one-way clutch assembly of claim 8, wherein the pivotable member includes a first portion extending in a first direction from the axis of rotation and a second portion extending in a second direction from the first portion, the movable member being configured to apply force to one of the first portion and the second portion.

10. The controllable one-way clutch assembly of claim 9, further comprising a resilient member arranged to apply a bias force to the other of the first portion and the second portion.

11. The controllable one-way clutch assembly of claim 9, wherein the movable member is mechanically coupled to the one of the first portion and the second portion to move the pivotable member from the engaged position to the disengaged position and from the disengaged position to the engaged position.

12. The controllable one-way clutch assembly of claim 8, wherein the second annular ring has a face extending generally orthogonal to the axis of rotation, the second annular ring further comprising a channel opening to the face and in communication with the pocket, the electromechanical actuator being disposed in the channel.

13. The controllable one-way clutch assembly of claim 8, wherein the electromechanical actuator comprises a solenoid and the movable member comprises an armature of the solenoid.

14. A controllable one-way clutch comprising:
a first race having a periphery provided with a tooth; and
a second race having a rocker with an associated solenoid, the rocker being pivotable between a first position engaged with the tooth and a second position disengaged from the tooth, and the solenoid having an armature arranged to move the rocker from the first position to the second position and from the second position to the first position.

15. The controllable one-way clutch of claim 14, wherein the first race is an inner race, and the second race is an outer race arranged concentrically with the inner race.
